(19) United States
(12) Patent Application Publication
(10) Pub. No.: US 2026/0208472 A1
(43) Pub. Date: Jul. 23, 2026

(54) POLYOLEFIN CO-EXTRUDED FILM FOR LIQUID-LIQUID MULTI-CHAMBER INFUSION BAGS, AND PREPARATION METHOD AND APPLICATION THEREOF

(71) Applicant: CHONGZHOU JUNJIAN MEDICAL PLASTICS PACKAGING CO., LTD., CHENGDU (CN)

(72) Inventors: LIPIN ZHAO, CHENGDU (CN); TING HE, CHENGDU (CN); FENG XIE, CHENGDU (CN); SHIYU LIANG, CHENGDU (CN); BAIJUN MA, CHENGDU (CN); KE HE, CHENGDU (CN); YOUQING WANG, CHENGDU (CN)

(21) Appl. No.: 19/452,528

(22) Filed: Jan. 19, 2026

(30) Foreign Application Priority Data
Jan. 21, 2025 (CN) 202510093161.8

(51) Int. Cl. B32B 27/08; B29C 48/00; B29C 48/21; B29C 48/28; B29C 48/87; B29K 23/00; B29K 25/00; B29K 105/00; B32B 27/30; B32B 27/32; B32B 37/04; B32B 37/06; B32B 37/10; B32B 38/00

(52) U.S. Cl. CPC B32B 27/08; B29C 48/022; B29C 48/21; B29C 48/28; B29C 48/87; B32B 27/302; B32B 27/32; B32B 37/04; B32B 37/06; B32B 37/10; B32B 38/0036; B29K 2023/08; B29K 2023/14; B29K 2025/08; B29K 2105/0067; B29K 2105/0085; B29K 2105/0088; B32B 2250/02; B32B 2250/246; B32B 2307/31; B32B 2307/7375; B32B 2309/02; B32B 2309/04; B32B 2309/12; B32B 2323/04; B32B 2323/10; B32B 2325/00; B32B 2439/80; B32B 2535/00

(57) ABSTRACT

The present invention provides a polyolefin co-extruded film for liquid-liquid multi-chamber infusion bags, and a preparation method and application thereof, relating to the technical field of infusion packing materials. The polyolefin co-extruded film for liquid-liquid multi-chamber infusion bags includes a heat sealing layer, an outer surface layer, and an intermediate layer. The heat sealing layer includes random copolymer polypropylene, terpolymer polypropylene, ethylene-α-olefin copolymer, and styrene block copolymer. The outer surface layer includes polypropylene and styrene block copolymer. The intermediate layer includes polypropylene and styrene block copolymer. The polyolefin co-extruded film achieves peelable seal by a two-step method and has a stable heat sealing strength, so as to prevent the accidental opening of peelable seal lines of an infusion bag and ensure smooth communication among various chambers during clinical use by extruding and opening the peelable seal lines.

### TECHNICAL FIELD

The present invention relates to the technical field of infusion packaging materials, specifically to a polyolefin co-extruded film for liquid-liquid multi-chamber infusion bags and a preparation method thereof.

### BACKGROUND

Multi-chamber bag infusion products include powder-liquid multi-chamber bags and liquid-liquid multi-chamber bags. A bag body is divided into a plurality of independent chambers by peelable seal, and different liquid medicines or powders are placed in different chambers.

During clinical use, the medical staff connects the chambers by means of extrusion, and the medicines can be intravenously injected into a patient after being mixed uniformly. Multi-chamber bags have many advantages, for example, medicines are dispensed in a closed system to avoid microbial contamination; the medicines can be used immediately upon mixing, the operation is convenient, and the medicine dispensing time is shortened; and the dosages of the medicines are dispensed in advance to avoid medical accidents caused by medicine dispensing errors.

The key technology of multi-chamber bags is to use a peelable seal line structure to divide a bag body into independent chambers. Before the use of medicines, peelable seal lines are configured to isolate different medicines. During use, the peelable seal lines can be smoothly opened to connect the chambers to mix the medicines. The heat sealing strength is a key index for evaluating a peelable seal line. On the one hand, in order to prevent the peelable seal line from being accidentally opened, the heat sealing strength of the peelable seal line cannot be too low. On the other hand, the heat sealing strength cannot be too high so as to ensure open smoothness during clinical use. In general, the heat sealing strength is 5-15 N/15 mm. The heat sealing strength of 5-10 N/15 mm of the peelable seal line is more suitable for powder-liquid double-chamber bags. However, for large-sized liquid-liquid multi-chamber bags that need to withstand greater impact, the heat sealing strength of the peelable seal line is preferably 10-15 N/15 mm. The existing peelable seal line technology uses a one-step hot welding process: film sheets are pressed by heated upper and lower molds, the heat of the upper and lower molds is transferred to an inner layer, and then, material polymer molecules of the inner layer are melted and entangled. For a one-step hot welding process, it is easy to form a peelable seal line with a heat sealing strength of 5-10 N/15 mm. However, when the heat sealing strength is 10-15 N/15 mm, due to a narrow welding temperature window of the peelable seal line of the film material used, the welding is unstable, and slight fluctuations in welding conditions (temperature, pressure, and time) may cause excessive heat sealing strength of the peelable seal line. In addition, the hot welding is not implemented in a closed environment, and the heat energy transferred to the film material during welding is also easily affected by the environment, resulting in the heat sealing strength of the peelable seal line deviating from the specified range.

### SUMMARY

An objective of the present invention is to provide a polyolefin co-extruded film for liquid-liquid multi-chamber infusion bags and a preparation method, which can achieve peelable seal and solid seal, and obtain stable heat sealing strength of peelable seal lines and good low-temperature impact resistance.

Another objective of the present invention is to provide an application of a polyolefin co-extruded film for liquid-liquid multi-chamber infusion bags.

Another objective of the present invention is further to provide a liquid-liquid multi-chamber infusion bag which is prepared from the above polyolefin co-extruded film for liquid-liquid multi-chamber infusion bags.

The present invention is implemented through the following technical solutions:

According to a first aspect, the present invention provides a polyolefin co-extruded film for liquid-liquid multi-chamber infusion bags, including a heat sealing layer, an outer surface layer, and an intermediate layer, where the heat sealing layer includes 30-40 parts by weight of random copolymer polypropylene, 20-30 parts by weight of terpolymer polypropylene, 5-15 parts by weight of ethylene-α-olefin copolymer, and 15-25 parts by weight of styrene block copolymer; the outer surface layer includes 80-95 parts by weight of polypropylene and 5-20 parts by weight of styrene block copolymer; and the intermediate layer includes 40-60 parts by weight of polypropylene and 40-60 parts by weight of styrene block copolymer.

Further, the melting point of the terpolymer polypropylene is 125-135° C., the melting point of the random copolymer polypropylene is 140-160° C., and the melting point of the ethylene-α-olefin copolymer is 60-110° C.

Further, the terpolymer polypropylene is a propylene-ethylene-butene copolymer, the random copolymer polypropylene is a propylene-ethylene copolymer, a comonomer of the ethylene-α-olefin copolymer is butene, hexene or octene, and the styrene block copolymer is a styrene-ethylene-ethylene-styrene block copolymer or a styrene-ethylene-butene-styrene block copolymer.

According to a second aspect, the present invention provides a method for preparing a polyolefin co-extruded film for liquid-liquid multi-chamber infusion bags, including the following steps: melting and plasticizing the heat sealing layer, the outer surface layer and the intermediate layer respectively through an extruder, and then allowing the heat sealing layer, the outer surface layer and the intermediate layer to enter a multi-layer film blowing die head; allowing the film blowing die head to blow downward to form a film bubble; subsequently, cooling the film bubble with purified water; shaping the film bubble with a collapsing board, and then, drawing the shaped film by a draw roller; and finally, allowing the drawn film to enter a winding roller for winding to obtain the polyolefin co-extruded film for liquid-liquid multi-chamber infusion bags.

According to a third aspect, the present invention provides an application of the polyolefin co-extruded film for liquid-liquid multi-chamber infusion bags in preparation of liquid-liquid multi-chamber infusion bags.

According to a fourth aspect, the present invention provides a liquid-liquid multi-chamber infusion bag which is prepared from the above polyolefin co-extruded film for liquid-liquid multi-chamber infusion bags.

Further, the method for preparing a liquid-liquid multi-chamber infusion bag includes the following steps:
S1. preliminary welding of peelable seal: performing preliminary welding on two polyolefin co-extruded films for liquid-liquid multi-chamber infusion bags to form a peelable seal line, where the heat sealing strength of the peelable seal line is 5-8 N/15 mm;
S2. bag making: performing hot-press welding on the co-extruded film with the peelable seal line obtained in S1 to form a solid seal line, where the heat sealing strength of the solid seal line is 30-45 N/15 mm; and
S3. performing moist heat sterilization on the liquid-liquid multi-chamber infusion bag obtained in S2 to obtain a peelable seal line with a heat sealing strength of 10-15 N/15 mm.

After the bag making is completed, the method also includes processes of welding mouth tubes, injecting liquid medicines, and inserting infusion plugs.

In the present invention, in step S1, the welding pressure of the preliminary welding is 0.4-0.6 MPa, a welding time is 0.4-0.8 s, and the welding temperature is 100-122° C.

In the present invention, in step S2, the hot-press welding pressure is 0.4-0.6 MPa, the welding time is 0.5-1 s, and the welding temperature is 140-150° C.; and in step S3, a moist heat sterilization temperature is 120-125° C., and the sterilization time is 10-15 min.

In the present invention, the width of the peelable seal line is 2-5 mm, and the width of the solid seal line is 1-4 mm.

The random copolymer polypropylene is prepared by simultaneous polymerization of ethylene molecules and propylene molecules. Since the irregular insertion of ethylene molecules into a main polymer chain hinders the crystalline arrangement of polymer molecules, the random copolymer polypropylene has a relatively low melting temperature and relatively high impact resistance. The chemical structure of the ethylene-α-olefin copolymer contains a random copolymerization sequence. The presence of the random copolymerization sequence makes the chain structure of the material looser and the molecular weight distribution more dispersed, so that the ethylene-α-olefin copolymer has better flexibility, stretchability and heat resistance. The terpolymer polypropylene is formed by introducing ethylene and butene onto a polypropylene molecular chain. Therefore, the regularity of the polypropylene molecular chain is disrupted, the crystallization temperature is reduced, and the terpolymer polypropylene has a low initial heat sealing temperature and a high heat sealing strength and has a relatively wide heat sealing window.

The ethylene-α-olefin copolymer has the lowest melting point, can undergo melting, movement and entanglement at a relatively low temperature, can achieve preliminary welding of peelable seal lines at a low temperature, and has high melt strength and flexibility, thereby ensuring the low-temperature impact performance of peelable seal lines and solid seal lines. The melting point of the terpolymer polypropylene is close to the moist heat sterilization temperature, which can cause molecular chain melting, movement and entanglement during the moist heat sterilization process, thereby further improving the heat sealing strength of the peelable seal line. The random copolymer polypropylene with a high melting point undergoes molecular chain melting, movement and entanglement during solid seal welding at a high temperature, thereby forming a solid seal line. At different temperatures, the molecular chains of the polymer are allowed to intersect and interlace with each other, resulting in a certain space structure of the molecular chains of the polymer and increasing the interaction force among molecules. On the one hand, the viscosity of the material can be increased, and the mechanical strength of the material can be improved. On the other hand, chain scission can be transformed into the extraction and extension of long chains, thereby improving the toughness of the material. By different degrees of entanglement of each component at different temperatures, the entanglement density can be reasonably controlled, thereby avoiding excessive entanglement density from affecting material forming and processing, and preventing entanglement from intensifying the reduction of the strength and toughness of the material. In the present invention, three polymer materials with different melting points are added to the heat sealing layer, so that the welding temperature range of the film material is wider, and a specific proportion of components can simultaneously achieve peelable seal lines with stable heat sealing strength and low-temperature impact performance of the film material.

The random copolymer polypropylene, terpolymer polypropylene and ethylene-α-olefin copolymer have different melting points and can undergo molecular chain melting, movement and entanglement under different temperature conditions, thereby forming peelable seal lines and solid seal lines with different heat sealing strengths. The first step in the formation of a peelable seal line is preliminary welding with a low welding temperature. At this time, the ethylene-α-olefin copolymer and part of the terpolymer polypropylene mainly undergo molecular chain melting, movement and entanglement, thereby forming a relatively low and stable heat sealing strength (5-8 N/15 mm) of the peelable seal line. The moist heat sterilization is skillfully used to enhance the peelable seal line. During this process, the peelable seal line undergoes a long-time sterilization process at a constant sterilization temperature. This step involves the melting, movement and entanglement of the molecular chains of the terpolymer polypropylene, thereby forming a relatively high heat sealing strength (10-15 N/15 mm) of the peelable seal line. At a higher solid seal temperature, the random copolymer polypropylene, terpolymer polypropylene and ethylene-α-olefin copolymer all participate in the molecular chain melting, movement and entanglement, thereby obtaining a solid seal line with a high heat sealing strength (30-45 N/15 mm).

The technical solutions of the present invention at least have the following advantages and beneficial effects:

1. By using the random copolymer polypropylene, terpolymer polypropylene and ethylene-α-olefin copolymer with different melting points as heat sealing materials and performing peelable seal through a two-step method, each component can achieve gradual melting, movement and entanglement during the welding process, thereby improving the melt strength, ensuring that the melt is not easy to break during the welding process, and enhancing the toughness of the infusion bag. Furthermore, the welding temperature window can be widened, the stability and uniformity of the heat sealing strength of the peelable seal line can be improved, and the quality of the infusion bag can be improved.

2. By achieving preliminary welding of peelable seal line under low temperature conditions, the molecular chain scission in the polyolefin co-extruded film caused by a relatively high initial welding temperature can be prevented, the precipitation of insoluble particles can be reduced, and the safety of the liquid medicine in the infusion bag can be ensured.

3. The intermediate layer uses polypropylene and polyethylene block polymers as main materials, so that the strength, toughness and barrier property of the polyolefin co-extruded film can be improved. The outer surface layer uses the polypropylene as a main material, so that the mechanical strength of the polyolefin co-extruded film can be improved, and a better printing property can also be provided.

4. The styrene block copolymer has a low glass transition temperature, so that the low-temperature impact resistance of the material can be improved, and the low-temperature properties of the film material can be maintained. The styrene block copolymer has good processing properties, so that the polyolefin co-extruded film and the infusion bag are easier to form and process during the production process, and the stability and durability of the film material and the infusion bag are maintained.

### BRIEF DESCRIPTION OF FIGURES

FIG. 1 shows the curve of a heat sealing strength versus a welding temperature in Example 1;

FIG. 2 shows the curve of a heat sealing strength versus a welding temperature in Example 2;

FIG. 3 shows the curve of a heat sealing strength versus a welding temperature in Comparative Example 1;

FIG. 4 shows the curve of a heat sealing strength versus a welding temperature in Comparative Example 2; and

FIG. 5 shows the curve of a heat sealing strength versus a welding temperature in Comparative Example 3.

### DETAILED DESCRIPTION

The present invention will be further described below with reference to specific examples, but the examples do not limit the present invention in any form. Unless otherwise specified, the raw material reagents used in the examples of the present invention are commercially available conventional raw materials and reagents.

### Example 1

Preparation of polyolefin co-extruded film for liquid-liquid multi-chamber infusion bags: a heat sealing layer, an outer surface layer and an intermediate layer are melted and plasticized respectively through an extruder, and then, the heat sealing layer, the outer surface layer and the intermediate layer are allowed to enter a multi-layer film blowing die head; the film blowing die head is allowed to blow downward to form a film bubble; subsequently, the film bubble is cooled with purified water; the film bubble is shaped with a collapsing board, and then, the shaped film is drawn by a draw roller; and finally, the drawn film is allowed to enter a winding roller for winding.

The heat sealing layer includes random copolymer polypropylene (propylene-ethylene copolymer), terpolymer polypropylene (propylene-ethylene-butene copolymer), ethylene-α-olefin copolymer (with hexene as the comonomer), and styrene block copolymer; the outer surface layer includes polypropylene and styrene block copolymer; and the intermediate layer includes polypropylene and styrene block copolymer, where the styrene block copolymer is styrene-ethylene-butene-styrene block copolymer.

The melting point of the propylene-ethylene-butene copolymer is 130° C., the melting point of the propylene-ethylene copolymer is 150° C., and the melting point of the ethylene-α-olefin copolymer (with hexene as the comonomer) is 80° C.

A method for preparing a liquid-liquid multi-chamber infusion bag includes the following steps:
S1. preliminary welding of peelable seal: preliminary welding is performed on two polyolefin co-extruded films for liquid-liquid multi-chamber infusion bags under the conditions that the welding pressure of the preliminary welding is 0.5 MPa and the welding time is 0.6 s, so as to form a peelable seal line, where the width of the peelable seal line is 4 mm;
S2. bag making: hot-press welding is performed on the co-extruded film with the peelable seal line obtained in S1 under the conditions that the hot-press welding pressure is 0.6 MPa, the welding time is 0.8 s and the welding temperature is 145° C., so as to form a solid seal line, where the width of the solid seal line is 2 mm; and
S3. moist heat sterilization is performed on the liquid-liquid multi-chamber infusion bag obtained in S2 under the conditions that the moist heat sterilization temperature is 120° C. and the sterilization time is 12 min, so as to further improve the heat sealing strength of the peelable seal line.

### Example 2

Preparation of polyolefin co-extruded film for liquid-liquid multi-chamber infusion bags: a heat sealing layer, an outer surface layer and an intermediate layer are melted and plasticized respectively through an extruder, and then, the heat sealing layer, the outer surface layer and the intermediate layer are allowed to enter a multi-layer film blowing die head; the film blowing die head is allowed to blow downward to form a film bubble; subsequently, the film bubble is cooled with purified water; the film bubble is shaped with a collapsing board, and then, the shaped film is drawn by a draw roller; and finally, the drawn film is allowed to enter a winding roller for winding.

The heat sealing layer includes random copolymer polypropylene (propylene-ethylene copolymer), terpolymer polypropylene (propylene-ethylene-butene copolymer), ethylene-α-olefin copolymer (with butene as the comonomer), and styrene block copolymer; the outer surface layer includes polypropylene and styrene block copolymer; and the intermediate layer includes polypropylene and styrene block copolymer, where the styrene block copolymer is styrene-ethylene-ethylene-styrene block copolymer.

The melting point of the propylene-ethylene-butene copolymer is 125° C., the melting point of the propylene-ethylene copolymer is 140° C., and the melting point of the ethylene-α-olefin copolymer (with butene as the comonomer) is 60° C.

A method for preparing a liquid-liquid multi-chamber infusion bag includes the following steps:
S1. preliminary welding of peelable seal: preliminary welding is performed on two polyolefin co-extruded films for liquid-liquid multi-chamber infusion bags under the conditions that the welding pressure of the preliminary welding is 0.4 MPa and the welding time is 0.8 s, so as to form a peelable seal line, where the width of the peelable seal line is 2 mm;
S2. bag making: hot-press welding is performed on the co-extruded film with the peelable seal line obtained in S1 under the conditions that the hot-press welding pressure is 0.6 MPa, the welding time is 0.5 s and the welding temperature is 150° C., so as to form a solid seal line, where the width of the solid seal line is 4 mm; and
S3. moist heat sterilization is performed on the liquid-liquid multi-chamber infusion bag obtained in S2 under the conditions that the moist heat sterilization temperature is 125° C. and the sterilization time is 10 min.

### Example 3

The differences between this example and Example 1 lie in that: the melting point of the propylene-ethylene-butene copolymer is 135° C., the melting point of the propylene-ethylene copolymer is 160° C., and the melting point of the ethylene-α-olefin copolymer (with octene as the comonomer) is 110° C.

### Example 4

The difference between this example and Example 1 lies in that: the intermediate layer of the polyolefin co-extruded film for liquid-liquid multi-chamber infusion bags includes 60% of polypropylene and 40% of styrene block copolymer in percentage by weight.

### Example 5

The difference between this example and Example 1 lies in that: the intermediate layer of the polyolefin co-extruded film for liquid-liquid multi-chamber infusion bags includes 50% of polypropylene and 50% of styrene block copolymer in percentage by weight.

### Example 6

The difference between this example and Example 1 lies in that: the outer surface layer of the polyolefin co-extruded film for liquid-liquid multi-chamber infusion bags includes 80% of polypropylene and 20% of styrene block copolymer in percentage by weight.

### Example 7

The difference between this example and Example 1 lies in that: the outer surface layer of the polyolefin co-extruded film for liquid-liquid multi-chamber infusion bags includes 95% of polypropylene and 5% of styrene block copolymer in percentage by weight.

### Comparative Example 1

In this Comparative Example, the heat sealing layer includes random copolymer polypropylene (propylene-ethylene copolymer), terpolymer polypropylene (propylene-ethylene-butene copolymer), and styrene block copolymer. The other conditions are the same as those in Example 1.

### Comparative Example 2

In this Comparative Example, the heat sealing layer includes random copolymer polypropylene (propylene-ethylene copolymer), ethylene-α-olefin copolymer (with hexene as the comonomer), and styrene block copolymer. The other conditions are the same as those in Example 1.

### Comparative Example 3

In this Comparative Example, the heat sealing layer includes random copolymer polypropylene (propylene-ethylene copolymer) and styrene block copolymer. The other conditions are the same as those in Example 1.

In formulae of the polyolefin co-extruded films for liquid-liquid multi-chamber infusion bags in Comparative Examples 1 to 3 and Examples 1 to 2, with each layer calculated on a 100% basis, component proportions of the intermediate layer, the outer surface layer and the heat sealing layer are as follows:

TABLE 1

| | | Comparative | Comparative | Comparative | Example | Example |
|---|---|---|---|---|---|---|
| Component | | Example 1 | Example 2 | Example 3 | 1 | 2 |
| Heat sealing | Random | 50% | 70% | 80% | 40% | 35% |
| layer | copolymer | | | | | |
| | polypropylene | | | | | |
| | Terpolymer | 30% | 0% | 0% | 30% | 30% |
| | polypropylene | | | | | |
| | Ethylene-α- | 0% | 10% | 0% | 10% | 15% |
| | olefin | | | | | |
| | copolymer | | | | | |
| | Styrene block | 20% | 20% | 20% | 20% | 20% |
| | copolymer | | | | | |
| Intermediate | Polypropylene | 40% | 40% | 40% | 40% | 40% |
| layer | Styrene block | 60% | 60% | 60% | 60% | 60% |
| | copolymer | | | | | |
| Outer | Polypropylene | 85% | 85% | 85% | 85% | 85% |
| surface | | | | | | |
| layer | Styrene block | 15% | 15% | 15% | 15% | 15% |
| | copolymer | | | | | |

The polyolefin co-extruded films prepared in the above comparative examples are welded under the same welding pressure and welding time as in Example 1 at different welding temperatures. Ten seal lines are produced from the same co-extruded films under the same welding temperature condition, which are then cut into 15 mm in width, 5 seal lines are subjected to a heat sealing strength test to obtain the heat sealing strength before sterilization, 5 seal lines are subjected to moist heat sterilization and then subjected to a heat sealing strength test to obtain the heat sealing strength after sterilization, and the average heat sealing strength of the seal lines before sterilization and after sterilization is recorded, as shown in the following table:

TABLE 2

| Pre- | | | | | | | | | | |
|---|---|---|---|---|---|---|---|---|---|---|
| limi- | Average heat sealing strength (N/15 mm) | | | | | | | | | |
| nary | Comparative | | Comparative | | Comparative | | | | | |
| welding | Example 1 | | Example 2 | | Example 3 | | Example 1 | | Example 2 | |
| temper- | Before | After | Before | After | Before | After | Before | After | Before | After |
| ature | sterili- | sterili- | sterili- | sterili- | sterili- | sterili- | sterili- | sterili- | sterili- | sterili- |
| (° C.) | zation | zation | zation | zation | zation | zation | zation | zation | zation | zation |
| 100 | 4 | 8.9 | 3.0 | 5.2 | 2.3 | 4.4 | 6.1 | 12 | 7.6 | 12.9 |
| 105 | 4.5 | 9.1 | 3.5 | 5.3 | 3.1 | 4.6 | 6.7 | 12.2 | 8.1 | 12.7 |
| 110 | 5.1 | 9.0 | 4.9 | 5.3 | 4.2 | 4.5 | 7.2 | 12.3 | 8.7 | 12.8 |
| 115 | 6.2 | 9.2 | 5.9 | 5.4 | 5 | 4.7 | 7.9 | 12.1 | 9.4 | 12.9 |
| 118 | 7.3 | 9.4 | 6.5 | 5.7 | 6.2 | 5.2 | 9.2 | 12.3 | 10.5 | 12.8 |
| 120 | 9.2 | 9.6 | 7.2 | 6.2 | 7.1 | 5.8 | 10.1 | 12.4 | 11.4 | 13 |
| 122 | 12.8 | 9.7 | 8.6 | 7.0 | 8.2 | 6.5 | 11.8 | 13 | 15 | 13.6 |
| 125 | 24.2 | 17.8 | 13.2 | 9.0 | 12 | 8.3 | 23.9 | 22.8 | 28 | 27.6 |
| 130 | 35.2 | 30.4 | 20.9 | 18.2 | 20.4 | 15.2 | 35.1 | 34.4 | 39.0 | 38.7 |
| 135 | 40.1 | 38.0 | 33.1 | 29.1 | 31.2 | 27.1 | 40.3 | 40.1 | 41.2 | 40.1 |
| 140 | 40.6 | 39 | 40.2 | 38.2 | 39 | 36.3 | 40.5 | 40 | 41.5 | 40.8 |

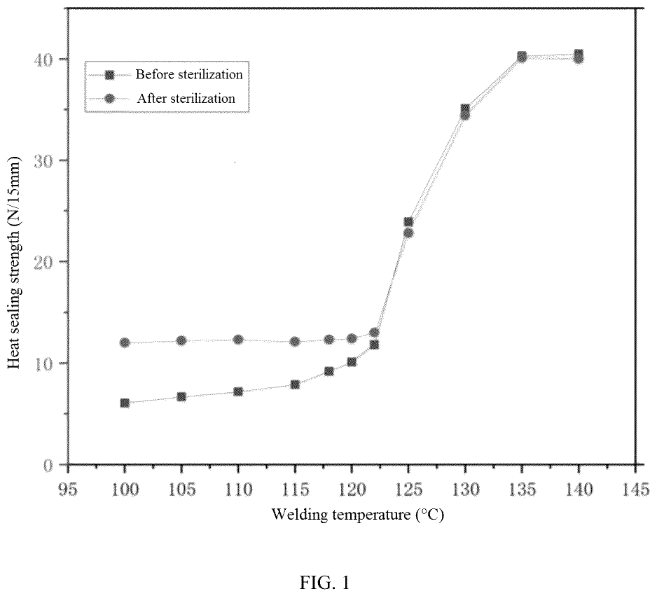

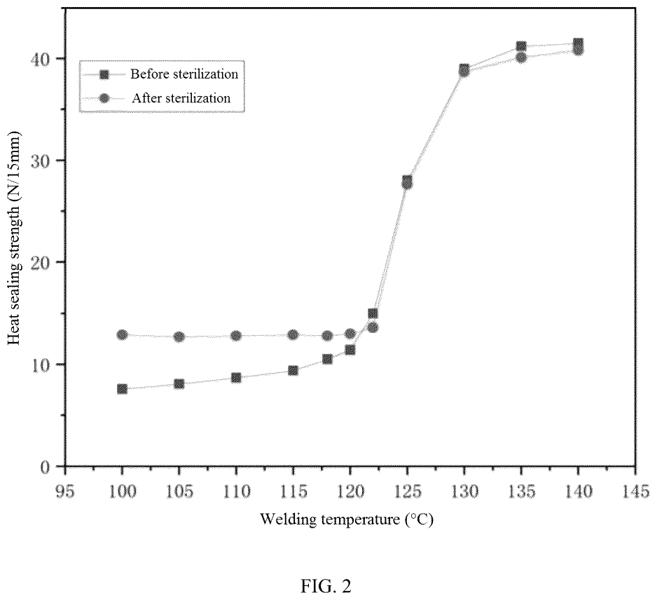

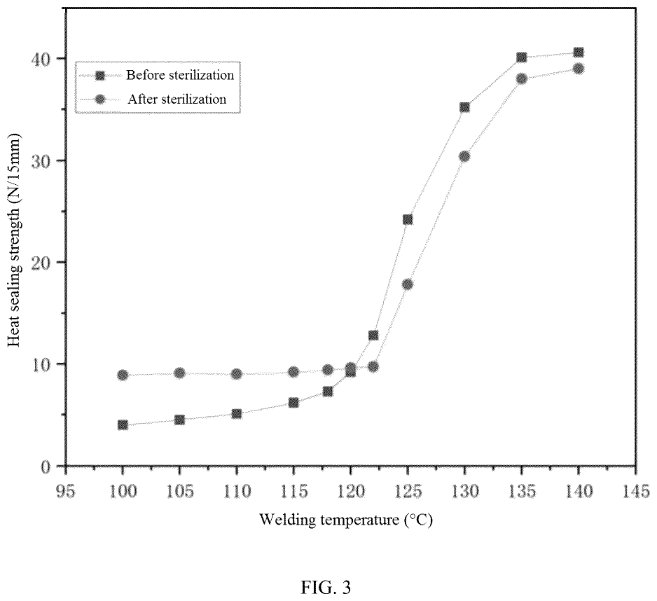

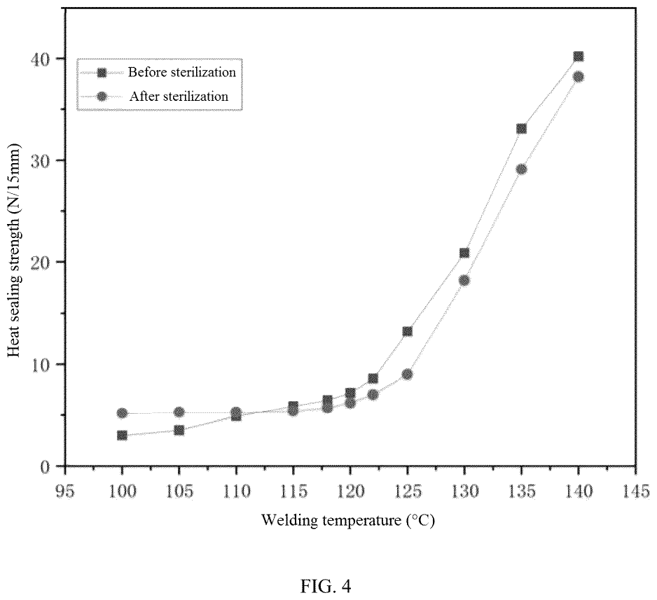

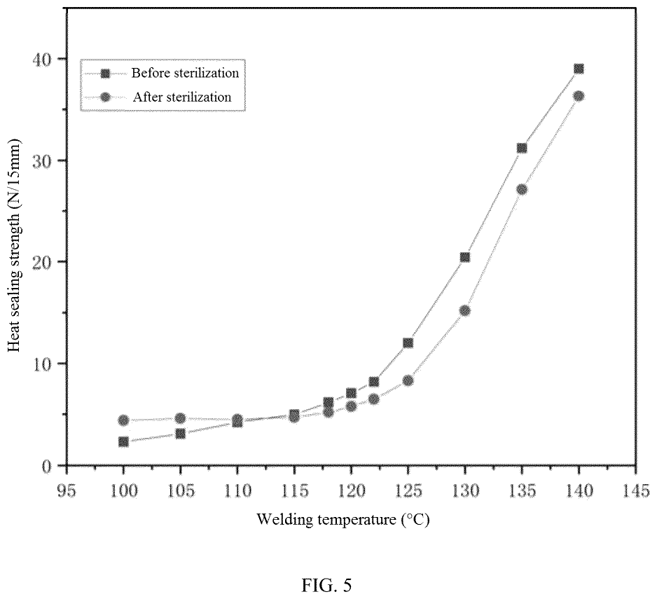

According to Table 2 and FIG. 1 to FIG. 5, it can be seen that for the comparative examples, the preliminary welding temperature needs to be controlled within a very narrow range (less than PQC to achieve a heat sealing strength of 10-15 N/15 mm after sterilization. In the examples, the preliminary welding temperature is within the range of 100-122° C., a peelable seal line with a heat sealing strength of 5-10 N/15 mm can be formed, and after moist heat sterilization, the heat sealing strength of the peelable seal line is increased to 10-15 N/15 mm. The welding window of the peelable seal line of the polyolefin co-extruded film prepared by the present invention is wide, so that the production process control is easier.

The heat sealing strength of the peelable seal line before and after sterilization of the polyolefin co-extruded film in Examples 3 to 7 is detected. The results show that the heat sealing strength of the peelable seal line before and after sterilization in Examples 3 to 7 is not significantly different from that in Example 1, indicating that under the conditions of Examples 3 to 7, the peelable seal line has a relatively wide welding window and a relatively high heat sealing strength.

The heat sealing quality (including the magnitude of the heat sealing strength and uniformity) of the peelable seal line will affect the properties of a liquid-liquid multi-chamber soft bag. If the heat sealing strength is too low, it may cause the peelable seal line to open accidentally when the soft bag is dropped. If the heat sealing strength of the peelable seal line is too high, it will cause difficult opening of the bag during clinical use. Therefore, it is necessary to perform a detection test on the quality of the peelable seal line of the infusion bag. A test method is as follows:

A liquid-liquid multi-chamber infusion bag is prepared according to the proportions in Table 1. Comparative Examples 1 to 3 and Examples 1 to 2 have different processes for preparing peelable seal lines and have the same process for preparing solid seal lines. Specifically, in Comparative Examples 1 to 3, the welding temperature of the peelable seal line when the heat sealing strength after sterilization is 13 N/15 mm is used as the welding temperature of the peelable seal line, and moist heat sterilization is not performed; and in Examples 1 to 2, the welding temperature of the peelable seal line is 110° C., and after moist heat sterilization, the preparation of the liquid-liquid multi-chamber infusion soft bag is completed. The liquid-liquid multi-chamber infusion soft bag is packed according to a standard packing method and then placed for 7 days.

Heat sealing strength test of peelable seal line: 20 liquid-liquid multi-chamber infusion soft bags are selected randomly, sample lines with a width of 15 mm and a length of 100 mm are cut at middle positions of peelable seal lines, and a universal testing machine is used for testing according to a test for heat sealing strength (YBB00122003-2015).

Full carton drop test: A full carton of liquid-liquid multi-chamber infusion soft bags are dropped from a height of 2.8 m to hard ground, and then, the carton is opened to check whether peelable seal lines are opened.

Clinical simulation opening test: A liquid-liquid multi-chamber infusion soft bag is wound from the tail by two hands. As the bag is wound, the storage space for liquid medicines decreases and the pressure inside the bag increases until the peelable seal lines are connected and opened.

Insoluble particles: After the peelable seal lines are manually opened and the liquid medicines are uniformly mixed, a test for insoluble particulate matter of packing materials (YBB00272004-2015) is used for measuring, so as to count the number of particles of 5 t m and above in every 1 ml.

TABLE 3

| | | Com- | Com- | Com- | | |
|---|---|---|---|---|---|---|
| | | parative | parative | parative | Exam- | Exam- |
| Item | | Exam- | Exam- | Exam- | ple | ple |
| | | ple 1 | ple 2 | ple 3 | 1 | 2 |
| Welding temperature | | 123.5° | 127.5° | 128.5° | 110° | 110° |
| of peelable seal | | C. | C. | C. | C. | C. |
| Heat | Average | 13.5 | 12.4 | 12.1 | 12.4 | 12.8 |
| sealing | value | | | | | |
| strength of | Minimum | 9.0 | 8.4 | 8.1 | 12.1 | 12.6 |
| peelable | value | | | | | |
| seal | Maximum | 17.1 | 16.2 | 15.9 | 12.6 | 13.0 |
| | value | | | | | |
| | Standard | 3.4 | 3.1 | 2.9 | 0.5 | 0.7 |
| | deviation | | | | | |

| | | | | | |
|---|---|---|---|---|---|
| Opening proportion | 9% | 10% | 11% | 0% | 0% |
| of peelable seal | | | | | |
| dropping after | | | | | |
| Manual opening | Not | Not | Not | Smooth | Smooth |
| smoothness of the | smooth | smooth | smooth | | |
| insufficient welding | | | | | |
| rod is smooth | | | | | |
| Insoluble particle | 5.7 | 7.6 | 8.1 | 1.2 | 1.1 |
| count (particles/ml) | | | | | |

It can be seen from Table 3 that in the comparative examples, the welding temperature of the peelable seal line is relatively high and is higher than 120° C. In the examples, the welding temperature of the peelable seal line is relatively low, and the welding temperature window is relatively wide, so that the quality control is facilitated, and the energy consumption is less.

In the comparative examples, the standard deviation of the heat sealing strength of the peelable seal line is relatively large, indicating that the fluctuation in heat sealing strength is relatively large. In the examples, the standard deviation is small, indicating that the heat sealing strength is more stable.

In the comparative examples, weak seal lines are opened after dropping, which is because the minimum value of the heat sealing strength of the peelable seal line is relatively small, and the impact resistance of the peelable seal line is poor, making it prone to accidental opening.

In the examples, the heat sealing strength of the peelable seal line is uniform and stable, so that the peelable seal line can be manually opened more smoothly, and the clinical use experience is good.

The number of insoluble particles in the examples is smaller. In the comparative examples, however, a relatively high welding temperature of the peelable seal line in the comparative examples may cause molecular chain scission in the polyolefin co-extruded film and the resulting fragments to precipitate into the liquid medicine, resulting in a relatively large number of insoluble particles. This indicates that the infusion bag prepared in the examples is safer for patients.

The above descriptions are only preferred examples of the present invention and are not intended to limit the present invention, and those skilled in the art can make various modifications and changes to the present invention. Any modifications, equivalent replacements, improvements and the like made within the spirit and principle of the present invention shall fall within the scope of protection of the present invention.

What is claimed is:

1. A polyolefin co-extruded film for liquid-liquid multi-chamber infusion bags, comprising a heat sealing layer, an outer surface layer, and an intermediate layer, wherein the heat sealing layer comprises 30-40 parts by weight of random copolymer polypropylene, 20-30 parts by weight of terpolymer polypropylene, 5-15 parts by weight of ethylene-α-olefin copolymer, and 15-25 parts by weight of styrene block copolymer; the outer surface layer comprises 80-95 parts by weight of polypropylene and 5-20 parts by weight of styrene block copolymer; and the intermediate layer comprises 40-60 parts by weight of polypropylene and 40-60 parts by weight of styrene block copolymer.

2. The polyolefin co-extruded film for liquid-liquid multi-chamber infusion bags according to claim 1, wherein the melting point of the terpolymer polypropylene is 125-135° C., the melting point of the random copolymer polypropylene is 140-160° C., and the melting point of the ethylene-α-olefin copolymer is 60-110° C.

3. The polyolefin co-extruded film for liquid-liquid multi-chamber infusion bags according to claim 2, wherein the terpolymer polypropylene is a propylene-ethylene-butene copolymer, the random copolymer polypropylene is a propylene-ethylene copolymer, a comonomer of the ethylene-α-olefin copolymer is butene, hexene or octene, and the styrene block copolymer is a styrene-ethylene-ethylene-styrene block copolymer or a styrene-ethylene-butene-styrene block copolymer.

4. A method for preparing the polyolefin co-extruded film for liquid-liquid multi-chamber infusion bags according to claim 1, comprising the following steps: melting and plasticizing the heat sealing layer, the outer surface layer and the intermediate layer respectively through an extruder, and then allowing the heat sealing layer, the outer surface layer and the intermediate layer to enter a multi-layer film blowing die head; allowing the film blowing die head to blow downward to form a film bubble; subsequently, cooling the film bubble with purified water; shaping the film bubble with a collapsing board, and then, drawing the shaped film by a draw roller; and finally, allowing the drawn film to enter a winding roller for winding to obtain the polyolefin co-extruded film for liquid-liquid multi-chamber infusion bags.

5. An application of the polyolefin co-extruded film for liquid-liquid multi-chamber infusion bags according to claim 1 in preparation of liquid-liquid multi-chamber infusion bags.

6. A liquid-liquid multi-chamber infusion bag, prepared from the polyolefin co-extruded film for liquid-liquid multi-chamber infusion bags according to claim 1, wherein a method for preparing the liquid-liquid multi-chamber infusion bag comprises the following steps:
S1. preliminary welding of peelable seal: performing preliminary welding on two polyolefin co-extruded films for liquid-liquid multi-chamber infusion bags to form a peelable seal line, wherein the welding pressure of the preliminary welding is 0.4-0.6 MPa, the welding time is 0.4-0.8 s, the welding temperature is 100-122° C., and the heat sealing strength of the peelable seal line is 5-8 N/15 mm;
S2. bag making: performing hot-press welding on the co-extruded film with the peelable seal line obtained in S1 to form a solid seal line, wherein the heat sealing strength of the solid seal line is 30-45 N/15 mm; and
S3. performing moist heat sterilization on the liquid-liquid multi-chamber infusion bag obtained in S2 to obtain a peelable seal line with a heat sealing strength of 10-15 N/15 mm.

7. The liquid-liquid multi-chamber infusion bag according to claim 6, wherein in step S2, the hot-press welding pressure is 0.4-0.6 MPa, the welding time is 0.5-1 s, and the welding temperature is 140-150° C.; and in step S3, the moist heat sterilization temperature is 120-125° C., and the sterilization time is 10-15 min.

8. The liquid-liquid multi-chamber infusion bag according to claim 7, wherein the width of the peelable seal line is 2-5 mm, and the width of the solid seal line is 1-4 mm.
